(19) United States
(12) Patent Application Publication
(10) Pub. No.: US 2025/0319559 A1
(43) Pub. Date: Oct. 16, 2025

(54) FIXING MECHANISM AND FIXING DEVICE HAVING THE SAME

(71) Applicants: Asphetek Solution (Chengdu) Ltd., Chengdu (CN); Asphetek Solution Inc., Hsinchu (TW)

(72) Inventors: HSIANG TSAI, Hsinchu (TW); CHUNG-WU Liu, Hsinchu (TW); YU-PI Kuo, Hsinchu (TW)

(21) Appl. No.: 18/808,307

(22) Filed: Aug. 19, 2024

(30) Foreign Application Priority Data
Apr. 10, 2024 (CN) 202420734651.2

(51) Int. Cl. B23Q 3/08

(52) U.S. Cl. CPC B23Q 3/08; B23Q 2703/02

(57) ABSTRACT

A fixing mechanism and a fixing device. The fixing mechanism includes a bearing seat, a clamping assembly, and a magnetic assembly. The bearing seat supports a product. The clamping assembly includes a first clamping member and a second clamping member, positioned on opposite sides of the bearing seat. The clamping members are linked to move synchronously towards or away from the bearing seat, clamping or releasing the product. One clamping member is connected to an external drive mechanism. The magnetic assembly includes a first magnetic member on the clamping member facing the bearing seat and a second magnetic member on the bearing seat. The magnetic members attract each other to enhance clamping stability.

### FIELD

The subject matter herein generally relates to product fixation technology, and more particularly, to a fixing mechanism and a fixing device having the fixing mechanism.

### BACKGROUND

In actual production processes, a fixing fixture is needed to secure products to be processed. The fixing fixture includes clamping jaws and a cylinder to drive the clamping jaws for holding the product in place. However, due to potential errors in the operations of the cylinder or the clamping jaws, the fixing fixture may fail to accurately secure the product, which may cause damages to the product, leading to lower product yield.

### BRIEF DESCRIPTION OF THE DRAWINGS

Implementations of the present technology will now be described, by way of example only, with reference to the attached figures.

FIG. 1 is a diagrammatic view of a fixing mechanism according to an embodiment of the present application.

FIG. 2 is a diagrammatic view of the fixing mechanism in FIG. 1, showing a first clamping member and a second clamping member moving synchronously away from a bearing seat.

FIG. 3 is a diagrammatic view of a fixing mechanism according to another embodiment of the present application.

FIG. 4 is a diagrammatic view of a fixing device according to an embodiment of the present application.

### DETAILED DESCRIPTION

It will be appreciated that for simplicity and clarity of illustration, where appropriate, reference numerals have been repeated among the different figures to indicate corresponding or analogous members. In addition, numerous specific details are set forth in order to provide a thorough understanding of the embodiments described herein. However, it will be understood by those of ordinary skill in the art that the embodiments described herein can be practiced without these specific details. In other instances, methods, procedures, and members have not been described in detail so as not to obscure the related relevant feature being described. Also, the description is not to be considered as limiting the scope of the embodiments described herein. The drawings are not necessarily to scale and the proportions of certain portion may be exaggerated to better illustrate details and features of the present disclosure.

The term “comprising,” when utilized, means “including, but not necessarily limited to;” it specifically indicates open-ended inclusion or membership in the so-described combination, group, series, and the like.

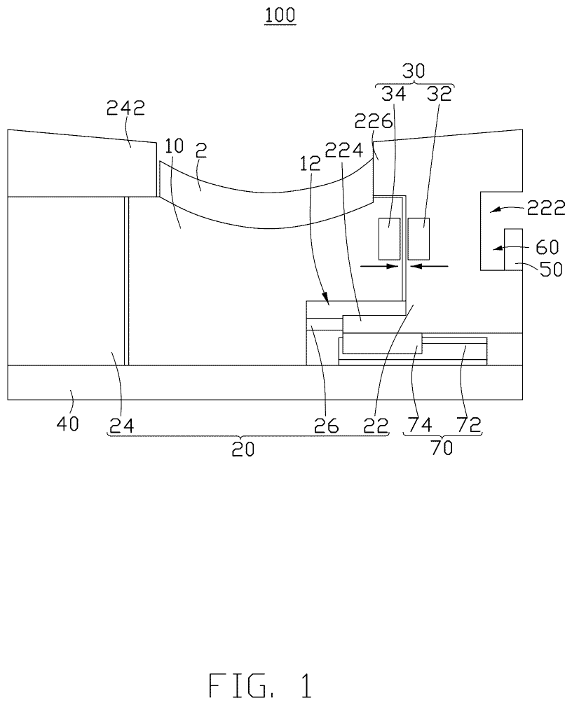

Referring to FIG. 1, a fixing mechanism 100 is provided according to an embodiment of the present disclosure. The fixing mechanism 100 may be used to clamp and fix a product 2, such as a convex lens, a concave lens, a flat mirror, or other objects that need to be clamped and fixed. The fixing mechanism 100 includes a bearing seat 10, a clamping assembly 20, and a magnetic assembly 30.

The bearing seat 10 is used to support the product 2 to be fixed. The bearing seat 10 is adapted to accommodate the product 2, and can be circular in shape.

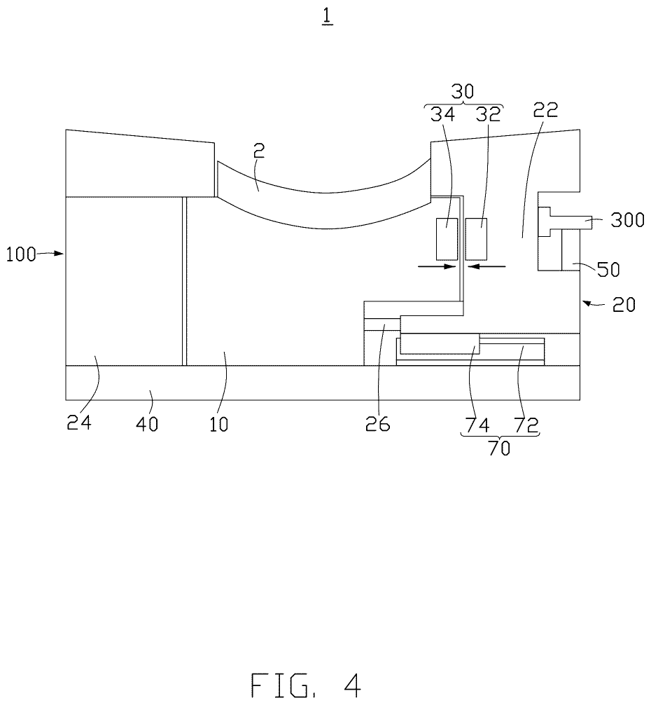

The clamping assembly 20 includes a first clamping member 22 and a second clamping member 24, which are respectively disposed on opposite sides of the bearing seat 10. The first clamping member 22 and the second clamping member 24 are linked to each other, so that the first clamping member 22 and the second clamping member 24 can move synchronously towards or away from the bearing seat 10, thereby clamping the product 2 on or releasing the product 2 from the bearing seat 10. One of the clamping members (22 or 24) is connected to an external driving mechanism 300 as shown in FIG. 4, which drives the movement of the clamping members (22 and 24) via a linkage.

The magnetic assembly 30 includes a first magnetic member 32 and a second magnetic member 34. The first magnetic member 32 is disposed on one side of the first clamping member 22 or the second clamping member 24 facing the bearing seat 10, and the second magnetic member 34 is disposed on the side of the bearing seat 10 facing the first clamping member 22 or the second clamping member 24. The first magnetic member 32 and the second magnetic member 34 are opposite to each other and can magnetically attract each other.

In this embodiment, the first magnetic member 32 is disposed on the side of the first clamping member 22 facing the bearing seat 10, and the second magnetic member 34 is disposed on the side of the bearing seat 10 facing the first clamping member 22. The external driving mechanism 300 is connected to the first clamping member 22. In other embodiments, the first magnetic member 32 may be disposed on the side of the second clamping member 24 facing the bearing seat 10, and the second magnetic member 34 can be disposed on the side of the bearing seat 10 facing the second clamping member 24. The external driving mechanism 300 is connected to the second clamping member 24.

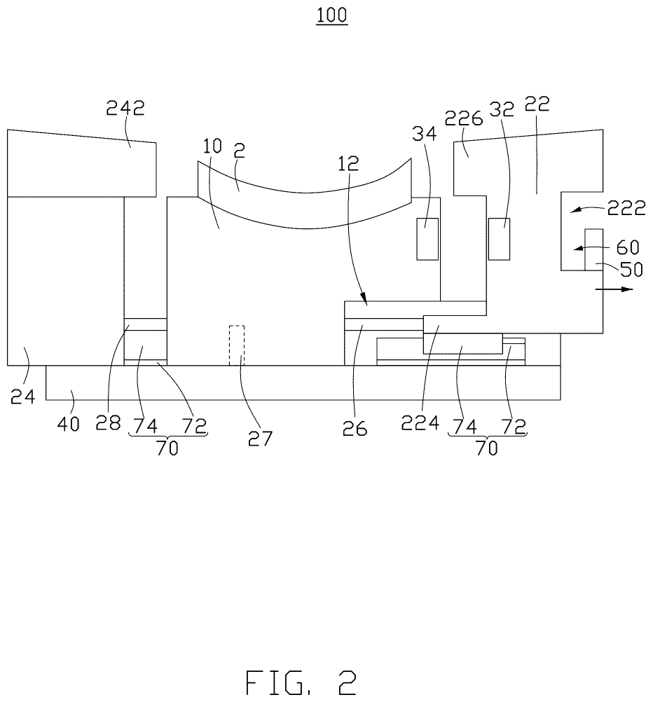

Referring to FIG. 2, when the fixing mechanism 100 is in use, the external driving mechanism 300 drives the first clamping member 22 to move away from the bearing seat 10, and during the movement of the first clamping member 22, the first clamping member 22 overcomes the magnetic attraction between the first magnetic member 32 and the second magnetic member 34. The first clamping member 22 and the second clamping member 24 move synchronously away from the bearing seat 10, allowing the product 2 to be placed on the bearing seat 10. Once the product 2 has been placed, the external driving mechanism 300 drives the first clamping member 22 to move closer to the bearing seat 10, and the first clamping member 22 and the second clamping member 24 move synchronously towards the bearing seat 10, thereby clamping the product 2 in place.

The fixing mechanism 100 further includes a base 40, and the bearing seat 10 is disposed on the base 40. The first clamping member 22 and the second clamping member 24 are slidably disposed on the base 40. Thus, the installation, transportation, and disassembly of the fixing mechanism 100 is facilitated.

The clamping assembly 20 further includes a first rack 26, a second rack 28, and a gear 27. The first rack 26 is connected to the first clamping member 22, and the second rack 28 is connected to the second clamping member 24. The gear 27 is engaged with both of the racks (26 and 28), and is rotatably disposed on the base 40. The external driving mechanism 300 moves the first clamping member 22 away from the bearing seat 10, causing the first rack 26 to move and drive the gear 27 to rotate, which in turn moves the second rack 28 and the second clamping member 24 in the opposite direction. When the external driving mechanism 300 moves the first clamping member 22 towards the bearing seat 10, the process is reversed, and the second clamping member 24 moves towards the bearing seat 10.

In this embodiment, the fixing mechanism 100 includes a traction member 50 disposed on one side of the first clamping member 22 facing away from the bearing seat 10. The traction member 50 is used to connect the first clamping member 22 to the external driving mechanism 300. The traction member 50 can be a pull ring, U-shaped member, or other functional objects that connect the first clamping member 22 to the external driving mechanism 300.

In this embodiment, the traction member 50 is substantially plate-shaped, and a slot 222 is formed on the side of the first clamping member 22 facing away from the bearing seat 10. The traction member 50 is disposed within the slot 222, and a gap 60 is formed between the traction member 50 and the bottom of the slot 222. The external driving mechanism 300 extends into the gap 60 and resists against one side of the traction member 50 facing the bottom of the slot 222. Thus, the traction member 50 can be embedded within the first clamping member 22, thereby reducing the space occupied by the first clamping member 22 and the traction member 50, and making the fixing mechanism 100 more compact.

The fixing mechanism 100 further includes two sliding components 70, and each of the clamping members (22 and 24) is associated with a corresponding sliding component 70. Each sliding component 70 includes a slide rail 72 and a slide block 74. The slide rail 72 is disposed on the base 40, and the slide block 74 is slidably disposed on the corresponding slide rail 72.

The clamping members (22 and 24) are connected to the corresponding slide blocks 74, allowing the clamping members (22 and 24) to slide on the base 40.

In this embodiment, a recess groove 12 is formed on one side of the bearing seat 10 facing the first clamping member 22. The recess groove 12 is located at the bottom of the bearing seat 10 and extends into the slide rail 72 corresponding to the first clamping member 22. A connecting portion 224 protrudes from the side of the first clamping member 22 facing the bearing seat 10. The connecting portion 224 connects to the slide block 74 and can move into the recess groove 12. Thus, the first clamping member 22 can fully connect to the bearing seat 10 via the magnetic attraction between the first magnetic member 32 and the second magnetic member 34, making the fixing mechanism 100 more compact and suitable for clamping products 2 in a limited space.

Each of the first clamping member 22 and the second clamping member 24 includes a contact portion extending towards the bearing seat 10. The contact portion of the first clamping member 22 is defined as a first contact portion 226, and the contact portion of the second clamping member 24 is defined as a second contact portion 242. The first contact portion 226 and the second contact portion 242 are located above the bearing seat 10, and are used to fix the product 2 on the bearing seat 10. Thus, the clamping members (22 and 24) can precisely clamp the product 2 and improve the movement accuracy of the clamping members (22 and 24).

In this embodiment, the first magnetic member 32 and the second magnetic member 34 can be magnets embedded in the clamping member 22 and the bearing seat 10, respectively. In another embodiment, the magnetic members 32 and 34 may be electromagnets. The first magnetic member 32 and the second magnetic member 34 can generate magnetism when being energized. In other embodiments, one of the first magnetic member 32 and the second magnetic member 34 is a magnet or an electromagnet, and the other of the first magnetic member 32 and the second magnetic member 34 is a ferromagnetic member that can be attracted by magnetism.

This embodiment of the fixing mechanism 100 ensures precise clamping of the product 2 by the cooperation among the bearing seat 10, the clamping assembly 20, the magnetic assembly 30, the base 40, traction member 50, and the sliding components 70. The magnetic attraction between the first magnetic member 32 and the second magnetic member 34 fixes the clamping members (22 and 24) in place, ensuring stability and enhancing the yield of the product 2. The compact and simple structure of the fixing mechanism 100 allows the fixing mechanism 100 to be used in limited spaces.

In other embodiments, there are two clamping assemblies 20, that is, the number of the clamping members 22 is two, and the number of the clamping members 24 is also two. The two clamping members 22 are symmetrically arranged around the bearing seat 10, and the two clamping members 24 are symmetrically arranged around the bearing seat 10, thereby clamping the product 2 from four directions. In another embodiment, there may be three clamping assemblies 20, so that the clamping members (22 and 24) can clamp the product 2 from multiple directions.

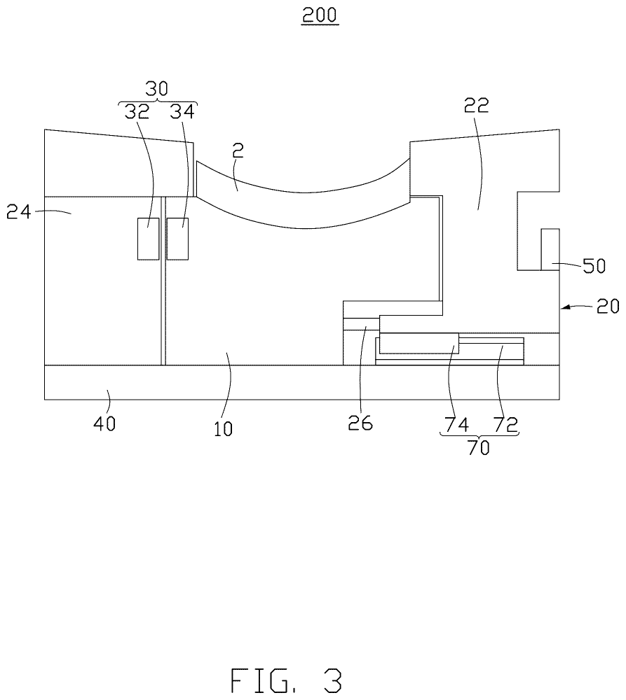

Referring to FIG. 3, another embodiment provides a fixing mechanism 200 similar to the fixing mechanism 100, with the difference being that the first magnetic member 32 is disposed on one side of the second clamping member 24 facing the bearing seat 10, and the second magnetic member 34 is disposed on one side of the bearing seat 10 facing the second clamping member 24.

Referring to FIG. 4, another embodiment provides a fixing device 1 that includes the fixing mechanisms 100 and 200 and a drive mechanism 300. The drive mechanism 300 connects to the first clamping member 22 of the fixing mechanism 100, and further extends into the gap 60 formed by the traction member 50 and the first clamping member 22. The drive mechanism 300 moves the first clamping member 22 towards or away from the bearing seat 10, causing the clamping members (22 and 24) to clamp or release the product 2 on the bearing seat 10.

This fixing device 1 ensures precise clamping of the product 2 through the cooperation among the bearing seat 10, the clamping assembly 20, the magnetic assembly 30, the base 40, the traction member 50, and the sliding components 70. The magnetic attraction between the first magnetic member 32 and the second magnetic member 34 fixes the clamping members (22 and 24) in place, ensuring stability and enhancing the yield of the product 2. The compact and simple structure of the fixing device 1 allows the fixing device 1 to be use in limited spaces.

Even though information and advantages of the present embodiments have been set forth in the foregoing description, together with details of the structures and functions of the present embodiments, the disclosure is illustrative only. Changes may be made in detail, especially in matters of shape, size, and arrangement of portion within the principles of the present exemplary embodiments, to the full extent indicated by the plain meaning of the terms in which the appended claims are expressed.

What is claimed is:

1. A fixing mechanism comprising:
a bearing seat configured to support a product;
a clamping assembly comprising a first clamping member and a second clamping member, the first clamping member and the second clamping member being disposed on opposite sides of the bearing seat, the first clamping member and the second clamping member being linked to each other, thereby causing the first clamping member and the second clamping member to move synchronously towards or away from the bearing seat to clamp the product on or release the product from the bearing seat, one of the first clamping member and the second clamping member being connected to an external driving mechanism and configured to move when driven by the external driving mechanism; and
a magnetic assembly comprising a first magnetic member and a second magnetic member, the first magnetic member being disposed on one side of the first or the second clamping member, facing the bearing seat, and the second magnetic member being disposed on one side of the bearing seat facing the first or the second clamping member, the first magnetic member and the second magnetic member being configured to magnetically attract each other.

2. The fixing mechanism of claim 1, further comprising a traction member disposed on one side of the first clamping member opposite the bearing seat, wherein the traction member is configured to connect the first clamping member to the external driving mechanism, and the first magnetic member is disposed on the side of the first clamping member facing the bearing seat.

3. The fixing mechanism of claim 2, wherein a slot is defined on the side of the first clamping member opposite the bearing seat, the traction member is disposed in the slot, a gap is defined between the traction member and a bottom of the slot, and the gap is configured to receive the external driving mechanism, thereby causing the external driving mechanism to resist against one side of the traction member facing the bottom of the slot.

4. The fixing mechanism of claim 1, further comprising a base, wherein the bearing seat is disposed on the base, and the first clamping member and the second clamping member are slidably disposed on the base.

5. The fixing mechanism of claim 1, further comprising two sliding assemblies, wherein each of the first clamping member and the second clamping member is slidably disposed on the base via a corresponding one of the two sliding assemblies.

6. The fixing mechanism of claim 5, wherein each of the two sliding assemblies comprises a slide rail and a slide block, the slide rail is disposed on the base, the slide block is slidably disposed on the slide rail, and the first clamping member or the second clamping member is connected to the slide block.

7. The fixing mechanism of claim 5, wherein a recess groove is defined on the side of the bearing seat facing the first clamping member, the slide rail corresponding to the first clamping member extends into the recess groove, the side of the first clamping member facing the bearing seat protrudes to form a connecting portion, the connecting portion is connected to the slide block and configured to move into the recess groove, and the first magnetic member is disposed on the side of the first clamping member facing the bearing seat.

8. The fixing mechanism of claim 4, wherein the clamping assembly further comprises a first rack, a second rack, and a gear, the first rack is connected to the first clamping member, the second rack is connected to the second clamping member, the first rack and the second rack are disposed on a same side of the bearing seat and spaced apart from each other, and the gear is engaged with the first rack and the second rack and rotatably disposed on the base.

9. The fixing mechanism of claim 1, wherein each of the first clamping member and the second clamping member has a contact portion extending towards the bearing seat, two contact portions of the first clamping member and the second clamping member are disposed above the bearing seat and configured to fix the product on the bearing seat.

10. The fixing mechanism of claim 1, wherein both of the first magnetic member and the second magnetic member are magnets or electromagnets.

11. A fixing device comprising:
a fixing mechanism comprising:
a bearing seat configured to bear a product to be fixed;
a clamping assembly comprising a first clamping member and a second clamping member, the first clamping member and the second clamping member being disposed on opposite sides of the bearing seat, the first clamping member and the second clamping member being linked to each other, thereby causing the first clamping member and the second clamping member to move synchronously towards or away from the bearing seat to clamp the product on or release the product from the bearing seat, one of the first clamping member and the second clamping member being connected to an external driving mechanism and configured to move when driven by the external driving mechanism; and
a magnetic assembly comprising a first magnetic member and a second magnetic member, the first magnetic member being disposed on one side of the first or the second clamping member, facing the bearing seat, and the second magnetic member being disposed on one side of the bearing seat facing the first or the second clamping member, the first magnetic member and the second magnetic member being configured to magnetically attract each other;
a drive mechanism connected to the first clamping member and configured to drive the first clamping member towards or away from the bearing seat, thereby causing the first clamping member to synchronously move the second clamping member to clamp or release the product on the bearing seat.

12. The fixing device of claim 11, further comprising a traction member disposed on one side of the first clamping member opposite the bearing seat, wherein the traction member is configured to connect the first clamping member to the external driving mechanism, and the first magnetic member is disposed on the side of the first clamping member facing the bearing seat.

13. The fixing device of claim 12, wherein a slot is defined on the side of the first clamping member opposite the bearing seat, the traction member is disposed in the slot, a gap is defined between the traction member and a bottom of the slot, and the gap is configured to receive the external driving mechanism, thereby causing the external driving mechanism to resist against one side of the traction member facing the bottom of the slot.

14. The fixing device of claim 11, further comprising a base, wherein the bearing seat is disposed on the base, and the first clamping member and the second clamping member are slidably disposed on the base.

15. The fixing device of claim 14, further comprising two sliding assemblies, wherein each of the first clamping member and the second clamping member is slidably disposed on the base via a corresponding one of the two sliding assemblies.

16. The fixing device of claim 15, wherein each of the two sliding assemblies comprises a slide rail and a slide block, the slide rail is disposed on the base, the slide block is slidably disposed on the slide rail, and the first clamping member or the second clamping member is connected to the slide block.

17. The fixing device of claim 15, wherein a recess groove is defined on the side of the bearing seat facing the first clamping member, the slide rail corresponding to the first clamping member extends into the recess groove, the side of the first clamping member facing the bearing seat protrudes to form a connecting portion, the connecting portion is connected to the slide block and configured to move into the recess groove, and the first magnetic member is disposed on the side of the first clamping member facing the bearing seat.

18. The fixing device of claim 14, wherein the clamping assembly further comprises a first rack, a second rack, and a gear, the first rack is connected to the first clamping member, the second rack is connected to the second clamping member, the first rack and the second rack are disposed on a same side of the bearing seat and spaced apart from each other, and the gear is engaged with the first rack and the second rack and rotatably disposed on the base.

19. The fixing device of claim 11, wherein each of the first clamping member and the second clamping member has a contact portion extending towards the bearing seat, two contact portions of the first clamping member and the second clamping member are disposed above the bearing seat and configured to fix the product on the bearing seat.

20. The fixing device of claim 11, wherein both of the first magnetic member and the second magnetic member are magnets or electromagnets.
